(19) United States
(12) Patent Application Publication
(10) Pub. No.: US 2026/0162857 A1
(43) Pub. Date: Jun. 11, 2026

(54) FLATTENING RESISTOR AND MANUFACTURE METHOD THEREOF

(71) Applicant: VIKING TECH CORPORATION, Hsinchu County (TW)

(72) Inventors: SHUN-HO KUO, Hsinchu County (TW); CHI-YU LU, Hsinchu County (TW)

(21) Appl. No.: 18/971,328

(22) Filed: Dec. 6, 2024

(51) Int. Cl. H01C 17/242; H01C 1/142; H01C 17/12; H01C 17/245

(52) U.S. Cl. CPC H01C 17/242; H01C 1/142; H01C 17/12; H01C 17/245

(57) ABSTRACT

A flattening resistor and a manufacturing method thereof are provided. The flattening resistor includes a substrate, a resistive layer, and an electrode layer. The present disclosure solves the problems of increased impedance and abnormal product characteristics caused by improper jointing of the interface between the electrode layer and the resistive layer, which includes using laser-cutting or grinding to eliminate the step difference of the interface and process the discontinuous structure of the electrode layer after the electrode layer process is completed.

### BACKGROUND OF THE INVENTION

### 1. Field of the Invention

The present disclosure relates to a resistor and a manufacturing method thereof, in particular to a flattening resistor and a manufacturing method thereof that maintains stable impedance under long-term energization.

### 2. Description of the Prior Art

Sputtering is a physical vapor deposition technology. In the manufacturing process of thin film resistors, sputtering process employ electricity to deposit and accumulate the sputtered target material atoms or molecules through the metal mask on the semiconductor wafer or glass or ceramics to form a film of specific shape.

A large amount of heat energy is generated during the sputtering process, which causes the mask to be exposed to the heat source and expanded by heat. The pattern of the mask is deviated from its relative position on the substrate. Due to pattern deviation, the target material will be oversprayed during the sputtering process, which affects dimensional stability.

Due to the characteristics of conventional printing techniques, there are issues of uneven thickness and excessive step differences in the contact area between the electrode layer and the resistor layer, which forms barrier that restricts electron migration and further increase impedance.

In addition, the printing techniques may also cause result in excess material splattering at the edges of the printed layer, which causes discontinuous contour structure of the electrode layer, uneven current distribution, and complicated current paths.

The above three situations may cause the performance of the resistor to become unstable, thereby affecting the consistency and reliability of the product. In addition, these situations may also cause local overheating problems, which further affects the reliability of the components and may lead to a decrease in the thermal stability of the resistors.

### SUMMARY OF THE INVENTION

In order to solve the above problems, the present disclosure provides a flattening resistor and a manufacturing method thereof to solve the technical problems of uneven height difference in the contact area between the electrode layer and the resistive layer of the conventional resistor, such as forming barrier that restricts electron migration, and increased impedance to the flow of electricity. In this case, the performance of the resistor will become unstable which may affect the consistency and reliability of the product. In addition, it may also cause local overheating problems, which further affects the reliability of the components and may lead to a decrease in the thermal stability of the resistors.

The present disclosure provides a manufacturing method of flattening resistor, comprising:
disposing a substrate;
forming an electrode layer on both ends of the substrate;
forming a tangential concave platform by laser-cutting or grinding a surface of the electrode layer;
forming a resistive layer covering the tangential concave platform of the electrode layer; and
forming a protective layer on the resistive layer.

Preferably, a length of the tangential concave platform of the electrode layer is less than or equal to half of a length of the electrode layer.

Preferably, the tangential concave platform comprises a tangent angle of 40°-120°.

Preferably, a centerline average surface roughness of a surface of the tangential concave platform is 0.1 nm-10 μm.

Furthermore, the present disclosure further provides a flattening resistor, comprising:
a substrate;
an electrode layer disposed at both ends of the substrate, the electrode layer comprises a tangential concave platform;
a resistive layer disposed on a surface of the substrate, wherein the resistive layer is connected to the electrode layer; and
a protective layer disposed on the resistive layer and exposes the electrode layer.

Preferably, a length of the tangential concave platform of the electrode layer is less than or equal to half of a length of the electrode layer.

Preferably, the tangential concave platform has a tangent angle of 40°-120°.

Preferably, a centerline average surface roughness of a surface of the tangential concave platform of the electrode layer is 0.1 nm-10 μm.

The electrode layer of the present disclosure is provided with a tangential concave platform to increases the flatness, thickness consistency, and bonding stability of the contact surface between the electrode layer and the resistive layer, which solves the technical problems caused by the height difference of the interface of the conventional resistor and the discontinuous contour structure of the electrode layer, such as uneven current distribution, complicated current paths, local overheating, prone to deformation, and poor contact under long-term energization. Therefore, the present disclosure reduces the impedance change rate of the resistor under long-term energization and increase the quality consistency, reliability, and thermal stability of the product.

### BRIEF DESCRIPTION OF THE DRAWINGS

FIG. 1 is a top view of the flattening resistor of the present disclosure.

FIGS. 2-5 are schematic diagrams of the manufacturing process of the flattening resistor of the present disclosure.

FIG. 6 is a partial enlarged view of area A in FIG. 1.

FIG. 7 is a flow chart of the manufacturing method of the flattening resistor of the present disclosure.

### DESCRIPTION OF THE PREFERRED EMBODIMENTS

Each embodiment of the present disclosure will be described in detail below, and the drawings will be used as illustrations to facilitate readers to have a better understanding. It is appreciated that the drawings are for schematic purposes only and do not represent the actual size or quantity of components. Some details may not be fully depicted in order to maintain conciseness in the drawing.

For conciseness of the description, a rectangular resistor is exemplified as an example, but it is appreciated that it is intended for illustration purposes and not to limit the present disclosure. The flattening resistor of the present disclosure can be implemented in any shape.

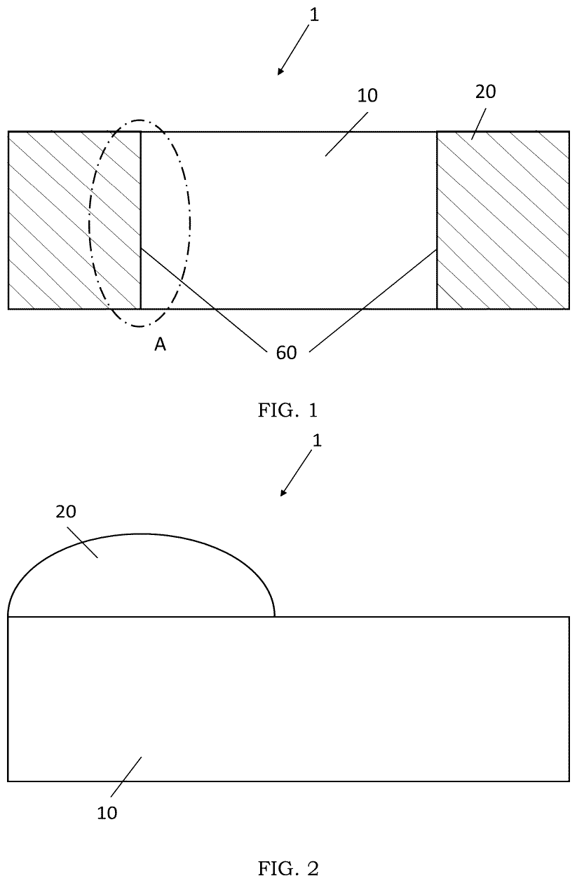

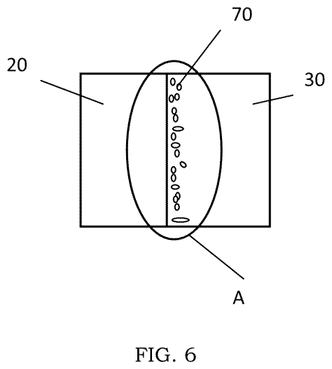

Please refer to FIGS. 1 to 6. FIG. 1 is a top view of the flattening resistor of the present disclosure. FIGS. 2-5 are schematic diagrams of the manufacturing process of the flattening resistor of the present disclosure. FIG. 6 is a partial enlarged view of area A in FIG. 1.

The flattening resistor 1 of the present disclosure is provided with a substrate 10, an electrode layer 20, a resistive layer 30, and a protective layer 40.

In step S01, as shown in FIG. 2, disposing a substrate 10 and printing an electrode layer 20 on both ends of the substrate 10 to form two electrodes.

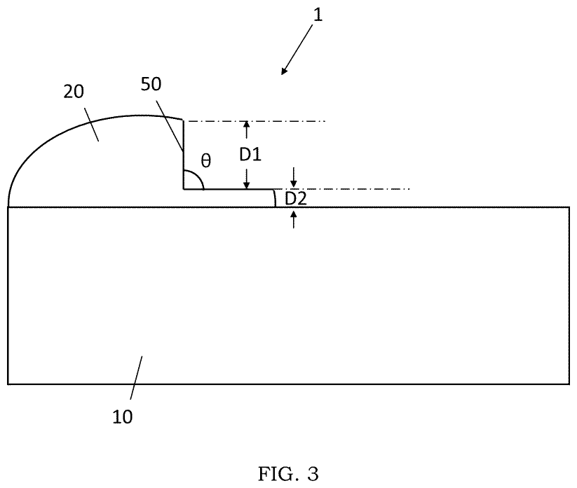

In step S02, as shown in FIG. 3, trimming a surface of the electrode layer 20 by laser-cutting or grinding to form a tangential concave platform 50. A length of the tangential concave platform 50 of the electrode layer is less than or equal to half of a length of the electrode layer, so that the highest point of the electrode layer does not change, thereby blocking the material from being over-sprayed. The centerline average surface roughness (also known as arithmetic mean height, Ra) of the trimmed surface of the electrode layer is less than 1 μm. The material of the electrode layer is an alloy, which may be made of metals, such as titanium, copper, aluminum, nickel, gold, carbon, silicon, combination thereof, etc.

The tangential concave platform 50 has a cutting angle θ of 40°-120°. The distance between the tangential concave platform 50 and the surface of the electrode layer 20 has a first step difference D1 of 0.1-20 μm. The distance between the tangential concave platform 50 and the surface of the substrate 10 has a second step difference D2 of 0.1-10 μm. The centerline average surface roughness (also known as arithmetic mean height, Ra) of the surface of the tangential concave platform 50 is 0.1-10 μm.

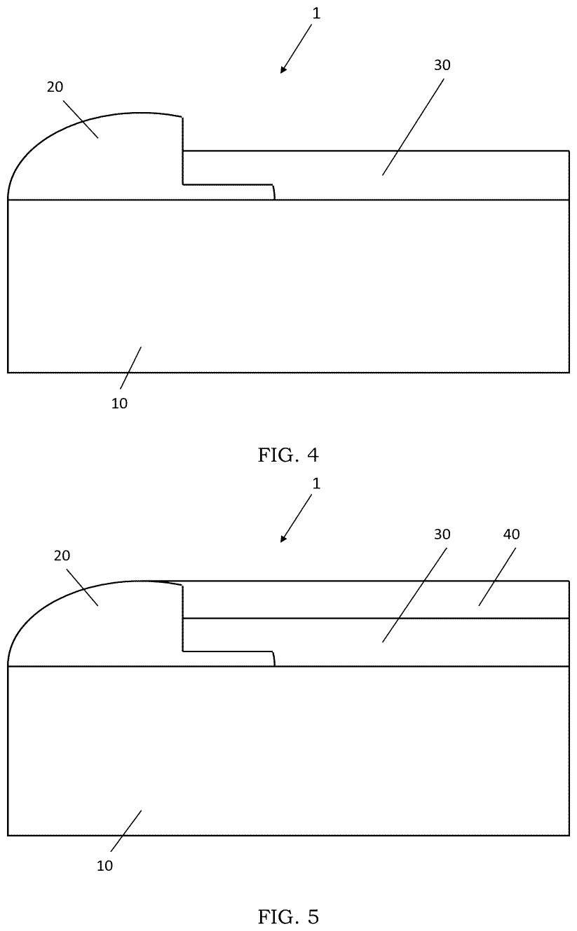

In step S03, as shown in FIG. 4, sputtering the resistive layer 30 on the substrate 10 and the electrode layer 20. The resistive layer 30 covers the substrate 10 and the tangential concave platform 50 of the electrode layer 20. The thickness of the resistive layer 30 is less than or equal to the first step difference D1 of the tangential concave platform 50 and greater than the second step difference D2 of the tangential concave platform 50. The resistive layer 30 contacts a side surface and a top surface of the tangential concave platform 50 to increase the contact surface area between the resistive layer 30 and the electrode layer 20, thereby preventing the resistive layer 30 from overspraying, keeping the thickness of the contact area between the resistive layer 30 and the electrode layer 20 consistent, and avoiding the problems that the resistive layer 30 is prone to deformation and warping by heat when energized due to the uneven thickness, which leads to excessive height difference in the contact area, forming of barrier that restricts electron migration, and increased impedance. The resistive layer is made of sputtered alloy, such as titanium, copper, aluminum, nickel, gold, carbon, silicon, combination thereof, etc.

In step S04, as shown in FIG. 5, printing a protective layer 40 on the resistive layer 30 and being cured. The total thickness of the protective layer 40 and the resistive layer 30 is greater than or equal to the first step difference D1 of the tangential concave platform 50. The material of the protective layer 40 may be epoxy resin or a mixture of epoxy resins.

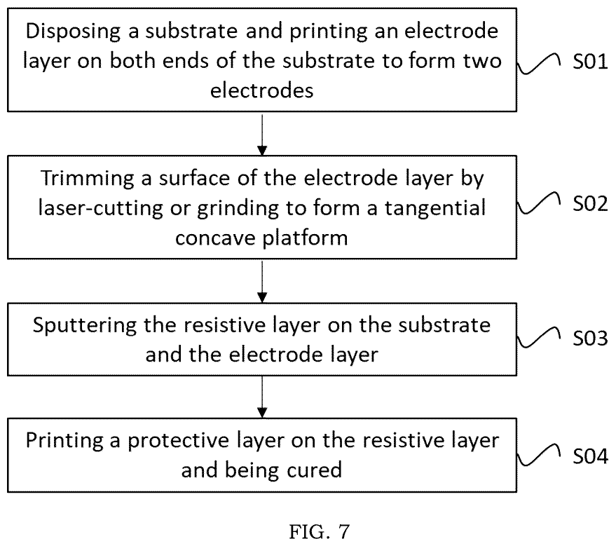

Please refer to FIG. 7, which is a flow chart of the manufacturing method of the flattening resistor of the present disclosure.

The area A of FIG. 7 is an interface area between the resistive layer 30 and the electrode layer 20. The resistance protrusions 70 on the area A are protrusions formed due to being limited by the obstruction of the tangential concave platform 50 during the sputtering process, so that the resistive layer 30 and the electrode layer 20 completely abut against each other, thereby keeping the contours of the electrode layer 20 and the resistive layer 30 consistent.

The printing, laser, grinding, sputtering, and curing processes used in the present disclosure can be implemented using conventional techniques to achieve the same effect. Therefore, the present disclosure will not be described redundantly for conciseness.

### [Example 1]: Detection of Impedance

In order to determine the effect of the flattening resistor of the present disclosure, conventional resistors lacking the technical features of the present disclosure were used as the control group, and the flattening resistor of the present disclosure was used as the experimental group. The impedance change rate of being powered on at the initial stage was tested (i.e. without changing any conditions). The results are shown in Table 1. The flattening resistor of the present disclosure can suppress the impedance change rate to 0.01-1%.

TABLE 1

| | | Minimum | Maximum | |
|---|---|---|---|---|
| | | impedance | impedance | Impedance |
| Detection of impedance | | (KΩ) | (KΩ) | change rate |
| Powered on at the | Conventional | 100 | 198 | 98% |
| initial stage (No | resistor | | | |
| conditions changed) | Flattening | 100 | 101 | 1% |
| | resistor | | | |

### [Example 2]: Detection of Resistance for Long-Term Power Supply

In order to determine the effect of the flattening resistor of the present disclosure, the present disclosure is used as an experimental group, and a conventional resistor lacking the flattening resistor of the present disclosure is used as a control group. The resistance change rate under the life test of being powered on for 1000 hours is tested. The results are shown in Table 2. The flattening resistor of the present disclosure can suppress the resistance change rate to 0.05%.

TABLE 2

| | | Minimum | Maximum | |
|---|---|---|---|---|
| | | resistance | resistance | Resistance |
| Life test | | value (KΩ) | (KΩ) | change rate |
| Powered on for | conventional | 100 | 110 | 10% |
| 1000 hours | resistance | | | |
| | Flattening | 100 | 100.05 | 0.05% |
| | resistance | | | |

As a result, the flattening resistor of the present disclosure can effectively reduce the instability of the resistance value. The resistance change rate and resistance change rate after being powered on for 1000 hours the flattening resistor of the present disclosure are 0.01-1% and 0.05%, respectively, compared with the conventional resistance of 98% and 10%. The flattening resistor has an increased stability of the resistance value. Therefore, it is proved that the present disclosure can prevent the resistance value from being unstable and maintain high resistance value accuracy and reliability under high temperature and long-term operation.

The electrode layer of the present disclosure is provided with a tangential concave platform to increases the flatness, thickness consistency, and bonding stability of the contact surface between the electrode layer and the resistive layer, which solves the technical problems caused by the height difference of the interface of the conventional resistor and the discontinuous contour structure of the electrode layer, such as uneven current distribution, complicated current paths, local overheating, prone to deformation, and poor contact under long-term energization. Therefore, the present disclosure reduces the impedance change rate of the resistor under long-term energization and increase the quality consistency, reliability, and thermal stability of the product.

What is claimed is:

1. A manufacturing method of flattening resistor, comprising:
disposing a substrate;
forming an electrode layer on both ends of the substrate;
forming a tangential concave platform by laser-cutting or grinding a surface of the electrode layer;
forming a resistive layer covering the tangential concave platform of the electrode layer; and
forming a protective layer on the resistive layer.

2. The manufacturing method according to claim 1, wherein a length of the tangential concave platform of the electrode layer is less than or equal to half of a length of the electrode layer.

3. The manufacturing method according to claim 1, wherein the tangential concave platform comprises a tangent angle of 40°-120°.

4. The manufacturing method according to claim 1, wherein a centerline average surface roughness of a surface of the tangential concave platform is 0.1 nm-10 μm.

5. A flattening resistor, comprising:
a substrate;
an electrode layer disposed at both ends of the substrate, the electrode layer comprises a tangential concave platform;
a resistive layer disposed on a surface of the substrate, wherein the resistive layer is connected to the electrode layer; and
a protective layer disposed on the resistive layer and exposes the electrode layer.

6. The flattening resistor according to claim 5, wherein a length of the tangential concave platform of the electrode layer is less than or equal to half of a length of the electrode layer.

7. The flattening resistor according to claim 5, wherein the tangential concave platform has a tangent angle of 40°-120°.

8. The flattening resistor according to claim 5, wherein a centerline average surface roughness of a surface of the tangential concave platform of the electrode layer is 0.1 nm-10 μm.
